(19) United States
(12) Patent Application Publication
(10) Pub. No.: US 2011/0123018 A1
(43) Pub. Date: May 26, 2011

(54) PHONE WITH A SECURITY FUNCTION

(75) Inventors: CHIH-FU CHUANG, Tu-Cheng (TW); WEN-CHING HSIAO, Tu-Cheng (TW)

(73) Assignee: HON HAI PRECISION INDUSTRY CO., LTD., Tu-Cheng (TW)

(21) Appl. No.: 12/948,767

(22) Filed: Nov. 18, 2010

(30) Foreign Application Priority Data
Nov. 23, 2009 (CN) 200910310205.9

(51) Int. Cl. H04M 1/00

(52) U.S. Cl. 379/387.01

(57) ABSTRACT

A phone comprises a microphone, an audio processing unit, and a switch. The phone detects a working status of the phone, and receives user input. The phone controls the switch to connect the microphone or to disconnect the microphone from the audio processing unit according to the working status and the user input.

### BACKGROUND

1. Technical Field

Embodiments of the present disclosure relate to mobile devices, and more particularly to a phone with a security function.

2. Description of Related Art

An operation system embedded in a smart phone, such as, WINDOWS MOBILE, ANDROID, or SYMBIAN, unavoidably come across communication security problems in practical applications. For example, a Trojan program can be installed undetectably in the operation system of the smart phone easily to wiretap a person's daily talk via a microphone of the smart phone. In this situation, the smart phone becomes compromised by the Trojan program. There remains a heretofore unaddressed need to overcome the limitations described.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of a phone having a security function of one embodiment of the present disclosure; and

FIG. 2 is a schematic diagram of signal controlling of the phone of FIG. 1.

### DETAILED DESCRIPTION

All of the processes described may be embodied in, and fully automated over, software code modules executed by one or more general purpose computers or processors. The code modules may be supported by any type of computer-readable medium or other storage device. Some or all of the methods may alternatively be embodied in specialized computer hardware or communication apparatus.

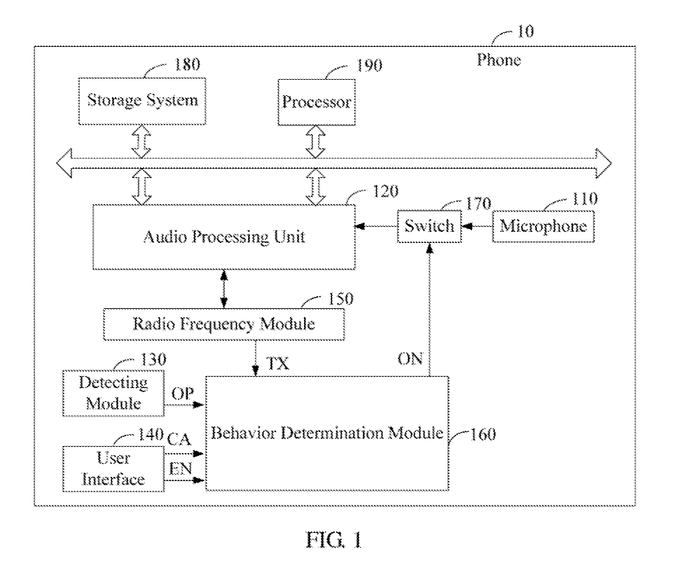

FIG. 1 is a schematic diagram of a phone 10 having a security function of one embodiment of the present disclosure. In one embodiment, the phone 10 comprises a microphone 110, an audio processing unit 120, a detecting module 130, a user interface 140, a radio frequency module 150, a behavior determination module 160, a switch 170, a storage system 180, and at least one processor 190. The modules 130-160 may comprise computerized codes in the form of one or more programs that are stored in the storage system 180. The computerized code comprises instructions that are executed by the at least one processor 190 to provide functions of the modules 130-160.

When a person makes a call with another person on the phone 10, the microphone 110 collects people's voice and converts the collected voices into audio signals to receive the audio signals, and the audio processing unit 120 processes the audio signals. In one embodiment, the switch 170 is connected between the microphone 110 and the audio processing unit 120, and is used to connect the microphone 110 to or disconnect the microphone 110 from the audio processing unit 120.

The detecting module 130 detects a working status of the phone 10. In one embodiment, the working status of the phone 10 comprises an unlocked status and a locked status. In one embodiment, the phone 10 is defined in the unlocked status if the phone 10 can be operated (e.g., keys/touchscreen of the phone 10 can be manipulated to perform operations). Similarly, the phone 10 is defined in the locked status if the phone 10 can not be operated For example, if the phone 10 is a slide phone or a flip phone, then the phone 10 is defined in the unlocked status when the phone 10 is sliding or flipping, otherwise, the phone 10 is defined in the locked status.

The user interface 140 receives user input, and transmits the user input to the behavior determination module 160. In one embodiment, the user input comprises dialing, off-hooking, and on-hooking. In one embodiment, the user interface 140 receives the user input from a keyboard or a touch screen of the phone 10.

The radio frequency module 150 transceives the audio signal, and determines whether power of the audio signal is changed. In one embodiment, the radio frequency module 150 comprises a transmitting portion and a receiving portion. The transmitting portion is used to receive an output signal from the audio processing unit 120, to modulate the output signal to a high frequency signal, and to transmit the high frequency signal to the another person via the phone 10 by a public switched telephone network (PSTN). The receiving portion is used to receive the audio signal with the high frequency from the another person via the PSTN, to demodulate the audio signal with the high frequency to a low frequency signal, and to transmit the low frequency signal to the audio processing unit 120. In one embodiment, the radio frequency module 150 determines whether the power of the audio signal is changed via the change of current on the transmitting portion or the receiving portion.

In one embodiment, the radio frequency module 150 uses a communication standard of global system for mobile communications (GSM), enhanced data rate for GSM evolution (EDGE), wideband code division multiple access (WCDMA), code division multiple access 2000 (CDMA2000), worldwide interoperability for microwave access (WIMAX), or wireless fidelity (Wi-Fi).

The behavior determination module 160 gathers the working status of the phone 10 and the user input to determine a user behavior. In one embodiment, the user behavior comprises not using, using, dialing, calling, and ending calling. In one embodiment, the working status of the phone 10 and the user input are gathered at a same time by the behavior determination module 160.

The behavior determination module 160 controls the switch 170 to connect the microphone 110 or to disconnect the microphone 110 from the audio processing unit 120 according to the user behavior to avoid the phone 10 being wiretapped.

In one embodiment, if the working status of the phone 10 detected by the detecting module 130 is in the locked status, then the behavior determination module 160 determines the user is not using the phone 10, and controls the switch 170 to disconnect the microphone 110 from the audio processing unit 120.

In one embodiment, if the working status of the phone 10 detected by the detecting module 130 is in the unlocked status and the dialing input is received by the user interface 140, then the behavior determination module 160 determines the user is dialing, and controls the switch 170 to disconnect the microphone 110 from the audio processing unit 120.

In one embodiment, if the working status of the phone 10 detected by the detecting module 130 is in the unlocked status and no control signals are input by the user interface 140, then the behavior determination module 160 determines the user is using the phone 10, and controls the switch 170 to disconnect the microphone 110 to the audio processing unit 120.

In one embodiment, if the working status of the phone 10 detected by the detecting module 130 is in the unlocked status and the off-hooking input is received by the user interface 140, then the behavior determination module 160 determines the user is calling, and controls the switch 170 to connect the microphone 110 to the audio processing unit 120.

In one embodiment, if the working status of the phone 10 detected by the detecting module 130 is in the unlocked status and the on-hooking input is received by the user interface 140, then the behavior determination module 160 determines the user is ending calling, and controls the switch 170 to disconnect the microphone 110 from the audio processing unit 120.

For example, if the user is ending calling, the power of the audio signals substantially drops. In that case, the behavior determination module 160 determines the user behavior is ending calling, and controls the switch 170 to disconnect the microphone 110 from the audio processing unit 120.

In one embodiment, the phone 10 determines the user behavior via the behavior determination module 160, and controls the switch 170 to connect the microphone 110 to or disconnect the microphone 110 from the audio processing unit 120 to avoid the phone 10 being wiretapped.

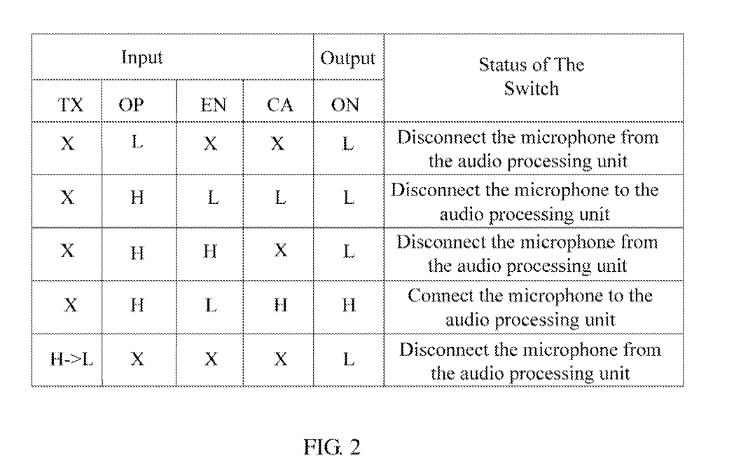

FIG. 2 is a schematic diagram of signal controlling of the phone 10 of FIG. 1.

As shown in FIG. 2, an “OP” column indicates an output signal of the detecting module 130, a “CA” column indicates an off-hook signal input from the user interface 140, an “EN” column indicates the on-hook signal input from the user interface 140, a “TX” column indicates an output signal of the radio frequency module 150, and an “ON” column indicates an output signal of the behavior determination module 160.

As shown, “X” in the OP column indicates that the working status of the phone 10 is either the unlocked status or the locked status, “H” in the OP column indicates that the working status of the phone 10 is, for example, the unlocked status, and “L” in the OP column indicates that the working status of the phone 10 is, for example, the locked status.

In this embodiment, if the working status of the phone 10 detected by the detecting module 130 is in the locked status, the OP column is marked with “L”, and the behavior determination module 160 controls the switch 170 to disconnect the microphone 110 from the audio processing unit 120.

If the working status of the phone 10 detected by the detecting module 130 is in the unlocked status, the OP column is marked with “H”, and no control signals are input from the user interface 140, then the behavior determination module 160 controls the switch 170 to disconnect the microphone 110 to the audio processing unit 120.

If the working status of the phone 10 detected by the detecting module 130 is in the unlocked status, the EN column is marked with “H”, then the behavior determination module 160 determines the user is ending calling, and controls the switch 170 to disconnect the microphone 110 from the audio processing unit 120.

If the working status of the phone 10 detected by the detecting module 130 is the unlocked status, and the CA column is marked with “H”, then the behavior determination module 160 controls the switch 170 to connect the microphone 110 to the audio processing unit 120.

If the power of the audio signals is substantially disappears, then the behavior determination module 160 determines the user is ending calling, and controls the switch 170 to disconnect the microphone 110 from the audio processing unit 120.

In one embodiment, the phone 10 determines the user behavior via the behavior determination module 160, and controls the switch 170 to connect the microphone 110 to or disconnect the microphone 110 from the audio processing unit 120 to avoid the phone 10 being wiretapped.

While various embodiments and methods of the present disclosure have been described, it should be understood that they have been presented by example only and not by limitation. Thus the breadth and scope of the present disclosure should not be limited by the above-described embodiments, but should be defined only in accordance with the following claims and their equivalents.

What is claimed is:

1. A phone, comprising:
a microphone operable to receive audio signals;
an audio processing unit operable to process the audio signals;
a switch connected between the microphone and the audio processing unit;
at least one processor;
a storage system; and
one or more programs that are stored in the storage system and are executed by the at least one processor, the one or more programs comprising:
a detecting module operable to detect a working status of the phone;
a user interface operable to receive user input; and
a behavior determination module operable to control the switch to connect the microphone or to disconnect the microphone from the audio processing unit according to the working status and the user input.

2. The phone as claimed in claim 1, wherein the working status comprises a locked status and an unlocked status.

3. The phone as claimed in claim 2, wherein the user input comprises dialing, off-hooking, and on-hooking.

4. The phone as claimed in claim 3, wherein in response to the behavior determination module determining that the user is not using the phone, the behavior determination module controls the switch to disconnect the microphone from the audio processing unit upon the condition that the phone is in the locked status.

5. The phone as claimed in claim 3, wherein in response to the behavior determination module determining that the user is using the phone, the behavior determination module controls the switch to disconnect the microphone from the audio processing unit upon the condition that the phone is in the unlocked status and no control signals are input by the user interface.

6. The phone as claimed in claim 3, wherein in response to the behavior determination module determining that the user is dialing, the behavior determination module controls the switch to disconnect the microphone from the audio processing unit upon the condition that the phone is in the unlocked status and a dialing input is received.

7. The phone as claimed in claim 3, wherein in response to the behavior determination module determining that the user is calling, the behavior determination module controls the switch to connect the microphone to the audio processing unit upon the condition that the phone is in the unlocked status and an off-hooking input is received.

8. The phone as claimed in claim 3, wherein in response to the behavior determination module determining that the user is ending calling, the behavior determination module controls the switch to disconnect the microphone from the audio processing unit upon the condition that an on-hook input is received.

9. The phone as claimed in claim 1, further comprising a radio frequency module operable to transceive the audio signal, and to determine if power of the audio signal is changed.

10. The phone as claimed in claim 9, wherein in response to the behavior determination module determining that the user is ending calling, the behavior determination module controls the switch to disconnect the microphone from the audio processing unit upon the condition that the power of the audio signals substantially drops.
